(19) United States
(12) Patent Application Publication
(10) Pub. No.: US 2009/0182442 A1
(43) Pub. Date: Jul. 16, 2009

(54) FRAMEWORK FOR RESULTS INTERPRETATION AND GUIDED REFINEMENT OF SPECIFICATIONS FOR PLC LOGIC VERIFICATION

(75) Inventors: NAGARAJAN SETHURAMAN, Bangalore (IN); Soumen De, Bangalore (IN); Chengyin Yuan, Rochester Hills, MI (US); Narahari K. Hunsur, Bangalore (IN)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., DETROIT, MI (US)

(21) Appl. No.: 12/352,988

(22) Filed: Jan. 13, 2009

Related U.S. Application Data
(60) Provisional application No. 61/020,865, filed on Jan. 14, 2008.

(51) Int. Cl. G05B 19/42; G06F 17/10

(52) U.S. Cl. 700/86; 703/2

(57) ABSTRACT

A system and method for interpreting formal verification results of PLC logic code used to control a manufacturing process, or other automated process, where the interpretation process does not require highly skilled technicians having significant experience in computer and mathematical algorithms. The verification process includes providing a verification results summary to check the compliance of the code with respect to the specifications. The verification results summary is analyzed and categorized to determine whether violations or errors are found in the results. The results can be depicted by assertion trees if a direct assertion between the PLC logic and the specifications can be provided. Alternatively, the results can be depicted by a reduced ladder logic if a direct assertion between the PLC logic and the specifications cannot be provided and a simulation is required. The specification refinement suggestions will be provided if the critical variable for violations is identified.

### CROSS-REFERENCE TO RELATED APPLICATIONS

This application claims the benefit of the filing date of U.S. Provisional Application Ser. No. 61/020,865 filed Jan. 14, 2008.

### BACKGROUND OF THE INVENTION

1. Field of the Invention

This invention relates generally to a system and method for providing a formal verification of programmable logic controller (PLC) logic code and, more particularly, to a system and method for providing a formal verification of PLC logic code for a manufacturing process where the verification results are presented in a format readily understandable by control engineers who may not have formal methods background.

2. Discussion of the Related Art

PLCs are modern industrial controllers that include hardware and software customized for industrial environments, such as manufacturing plants. The software, normally referred as the PLC logic code, which controls the PLC and industrial environments, is critical for controlling the operation of the plant, where both the safety and quality are of significant concern. The PLC logic code is used to control the manufacturing process, such as the operation of various robots and the like, which need to be verified so that the process works properly for the desired specification. The verified code thus becomes more credible and dependable, and the accompanying documents can now support the safety or quality certification process much better.

It is critical to test the PLC logic code before the code is provided for production so that engineers and technicians can ensure that the process will operate adequately and efficiently as intended. One traditional technique for testing the PLC code includes testing the code through a series of operations using emulation and simulation of the plant behavior. Another technique includes testing manufacturing processes by hardware prototyping.

One known technique for simulating a manufacturing process includes emulating the process in the virtual world using algorithms on a computer system. Using such an emulated or simulated system, engineers can conduct scenario studies of system performance and behavior correctness. This practice is sometimes referred to in the art as virtual commissioning or virtual validation. Modern emulation of certain manufacturing processes, such as automobile manufacturing processes, can mimic the physical operation of the process. In one process, various devices can be switched into and out of the virtual environment so as to determine the best device for that particular operation. For example, a particular manufacturing cell may require a robot to move a part from one location in the cell to another location in the cell. Modern virtual emulation processes allow the engineer to remove one virtual robot model from the manufacturing cell and replace it with another virtual robot model to compare the process performance using both machines.

It is understood in the art that using prototype test case based methods or simulation based methods for verifying a manufacturing process typically do not allow for testing of all scenarios to check the compliance of the PLC code. At best, the test based cases are as exhaustive as the domain knowledge or experience of the person controlling the test. Because the testing is not exhaustive or complete, there is a possibility that the PLC code can be successfully passed with the limited testing scenarios, but still includes errors.

It has been proposed in the art to use mathematical models of the operation of a manufacturing process and mathematically modeling all the scenarios of the operation of the process controlled by the PLC code. In one known mathematical model verification process, a verifier tool takes the inputs with the PLC logic code and process specifications that are required for logic verification.

The results of the verification process are provided to an operator who then analyzes the results to determine whether the control logics (PLC code) needs to be changed, the specifications need to be revised or some other action needs to be taken in order to make the process error-free. However, these types of PLC logic verification processes employing mathematical models and algorithms have typically required highly skilled operators to interpret the results. The verification process may be better served by presenting the results in a format that can be easily interpreted by lower skilled workers.

### SUMMARY OF THE INVENTION

In accordance with the teachings of the present invention, a system and method are disclosed for interpreting formal verification results of PLC logic code used to control a manufacturing process, or other automated process, where the interpretation process does not require highly skilled technicians having significant experience in computer and mathematical algorithms. The verification process includes mathematically modeling the PLC logic code, mathematically formulating the expected behavior of the logic code and providing a verification results summary to check the compliance of the code with respect to the specifications. The verification results summary is analyzed and categorized to determine whether violations or errors are found in the results. The results can be depicted by assertion trees if a direct assertion between the PLC logic and the specifications can be provided. Alternatively, the results can be depicted by a reduced ladder logic if a direct assertion between the PLC logic and the specifications cannot be provided and a simulation is required. Once the result interpretation is completed, an operator is guided by the framework to refine the specification to a level where the specification adequately represents the reality or expected behavior of the process and against which the PLC logic code verification can be performed or the verification results can be documented.

Additional features of the present invention will become apparent from the following description and appended claims, taken in conjunction with the accompanying drawings.

### BRIEF DESCRIPTION OF THE DRAWINGS

FIG. 1 is a flow chart diagram showing an overall formal verification process that includes a framework for a results interpretation and guided refinement of specification for verifying PLC logic in a manufacturing process;

FIG. 2 is a block diagram plan view of a system that provides a framework for results interpretation and guided refinement of specifications for verifying PLC logic in a manufacturing process;

FIG. 3 is a flow chart diagram showing classification of possible results in the PLC logic verification process of the invention;

FIG. 4 is an illustration of the results of an analysis provided by the PLC logic verification process of the invention for a direct assertion with no violations;

FIG. 5 is an illustration of the results of an analysis provided by the PLC logic verification process of the invention for a direct assertion with violations at all scenarios;

FIG. 6 is an illustration of the results of an analysis provided by the PLC logic verification process of the invention for a simulation with no violations;

FIG. 7 is an illustration of the results of an analysis provided by the PLC logic verification process of the invention for a simulation with violations at all scenarios;

FIG. 8 is an illustration of specifications for a simulation illustrating violations at some scenarios;

FIG. 9 is an illustration of the results of an analysis provided by the PLC logic verification process of the invention for a simulation with violations at some scenarios; and

FIG. 10 is an illustration of modified specifications for the simulation with violations at some scenarios.

### DETAILED DESCRIPTION OF THE EMBODIMENTS

The following discussion of the embodiments of the invention directed to a system and method for providing PLC logic verification of an assembly or manufacturing process is merely exemplary in nature, and is in no way intended to limit the invention or its applications or uses. For example, the present invention has particular application for assembly and manufacturing processes for automotive applications. However, as will be appreciated by those skilled in the art, the system and method for providing PLC logic verification of the invention will have application for many other types of processes.

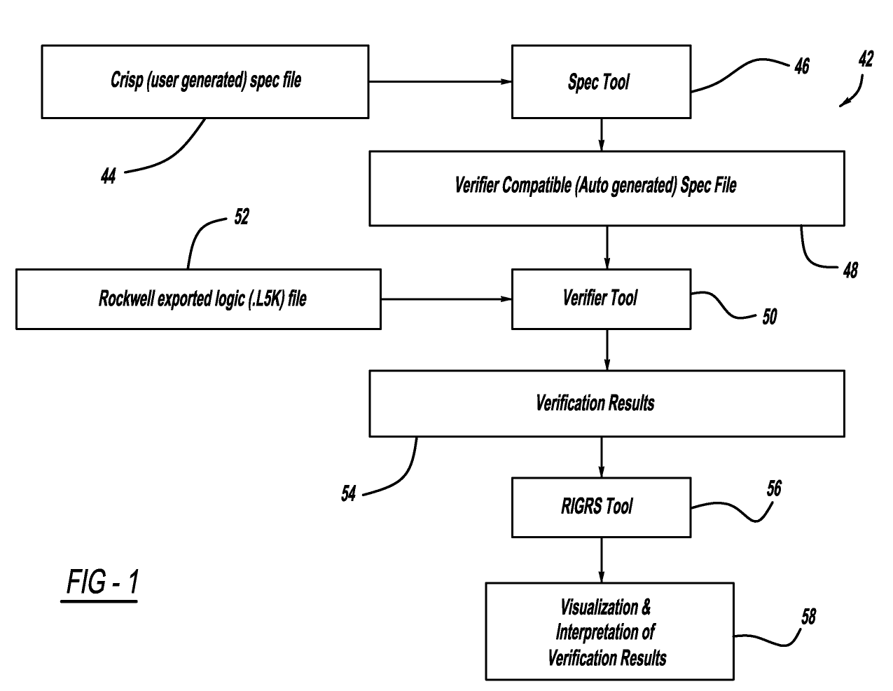

FIG. 1 is a flow chart diagram 42 showing the overall method for conducting formal verification of PLC logic in a manufacturing process, including a framework for a results interpretation and guided refinement of specifications. A user generates a specification file at box 44, sometimes referred to as a crisp file, and loads it into a specification tool at box 46. This type of specification file will allow the user to load and edit the specification file on the specification tool. The specification tool automatically converts the specification file to a verifier compatible file that is more machine readable at box 48. The verifier compatible specification file is then loaded into a verifier tool at box 50 along with an exported logic file at box 52. The verifier tool then proceeds to verify the logic against the specifications and outputs the results in a verification results box 54 and passes the verification results to a results interpretation and guided refinement of specifications (RIGRS) tool at box 56. The RIGRS tool then provides visualization and interpretation of the verification results at box 58 to allow the user to determine whether the specification provides the desired results for the particular operation.

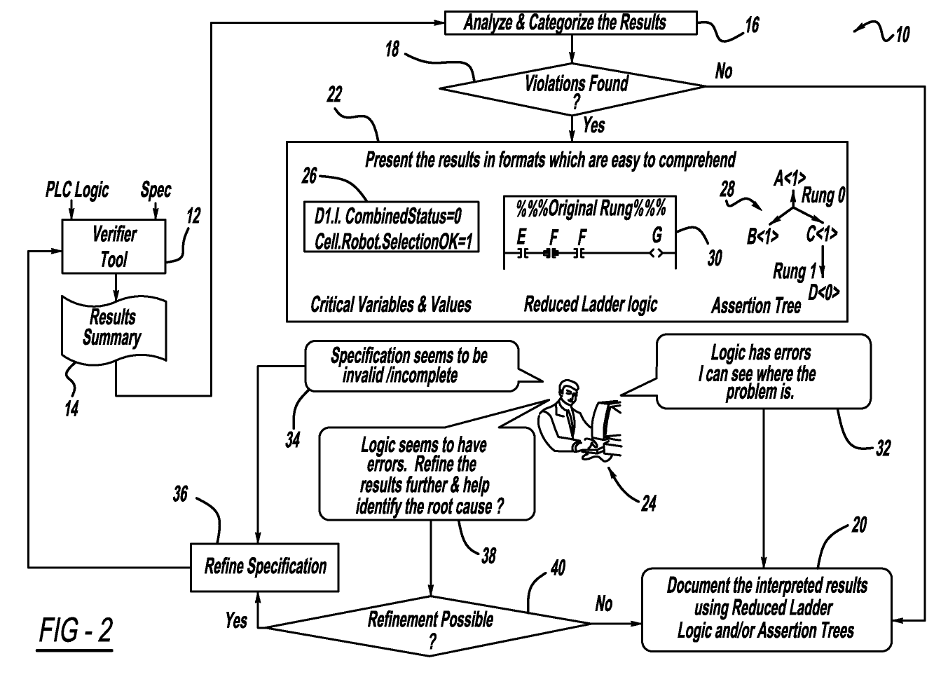

FIG. 2 is a block diagram of a system 10 for providing PLC logic verification, according to an embodiment of the present invention. The steps of the boxes 54, 56 and 58 of the process 42 are embodied in the system 10. As will be discussed in detail below, the system 10 provides a framework for results interpretation and guided refinement of specifications associated with an assembly and/or a manufacturing process. The system 10 includes a verifier tool 12 that receives PLC logic code and specifications as inputs. The specifications are an abstract representation of an expected behavior and may need several iterations based on interpretation of the verification results before the actual specifications can be represented. As discussed above, the verifier tool 12 uses the PLC logic code and the specifications that will be used by the assembly or manufacturing process so that an analysis of the process can be provided so that errors can be identified in the PLC logic and/or specifications prior to the actual operation of the process. The verifier tool 12 can run on any suitable computer based device that can be programmed with the PLC logic code and the specifications to provide a results summary 14 that identifies whether the PLC logic code has errors or violations that may affect the assembly and/or manufacturing performance.

At box 16, the system 10 analyzes and categorizes the results summary 14 to determine if any errors or violations in the simulation have occurred. As will be appreciated by those skilled in the art, any suitable analyzing and categorizing process can be used to analyze and categorize the results in the results summary 14. Once the results have been analyzed and categorized, the system 10 determines whether there are any errors or violations at decision diamond 18. If there are no errors or violations found in the verification analysis, then the system 10 documents the interpreted results at box 20 using, for example, reduced ladder logic and assertion trees.

As will be discussed in further detail below, the results can be depicted by an assertion tree if a direct assertion between the PLC logic and the specifications can be provided. If a direct assertion cannot be provided between the PLC logic and the specifications, the system 10 performs a simulation where the results are depicted by a reduced ladder logic. As is well understood to those skilled in the art, direct assertion is a process that employs equations for each line of code in the PLC logic, where the variables for the equations in one line of code are known, which can then be used to determine the variables in a next line of code and so on. For a simulation, more than one variable in a particular line of code is unknown so that a simulation of different values for the different variable needs to be calculated to determine the likely value for the unknown variables.

If the system 10 determines that there are violations or errors in the results summary 14, the system 10 will put the results showing the errors in a format or display 22 that is easy to read and understand by an operator 24. The display 22 can provide critical variables and values at box 26 that may identify a particular location in the assembly or manufacturing process, or other identifying feature. As discussed above, if a direct assertion can be provided between the PLC logic and the specifications, then the errors can be displayed by a direct assertion tree 28. If a direct assertion is not possible, the reduced PLC logic needs to be simulated for all of the possible scenarios for the given specifications. The errors, if found, can be understood with the help of a reduced ladder logic 30.

The operator 24 can readily see and understand the errors in the display 22, and will select one of three options for further processing based on the results At block 32, the operator 24 identifies the errors and immediately knows the location of the problem. The operator 24 can then document the errors at the box 20 reduced ladder logic or the assertion tree so that the PLC logic code. Alternatively, the operator 24 may see that the specifications seem to be invalid and/or incomplete at box 34 based on the errors shown in display 22, and may recommend that the specifications be refined at box 36. Also, the operator 24 may notice that the PLC logic seems to have errors, but is not sure what to do and may ask for further help to identify the root cause of the errors at box 38. The system 10 then will determine if specification refinement is possible at decision diamond 40, and if so, the specifications will be refined at the box 36. Otherwise, the errors will merely be documented at the box 20 for future analysis. For example, the number of errors or the size of the errors in the display 22 may be so large that the operator 24 is not able to fully understand their extent.

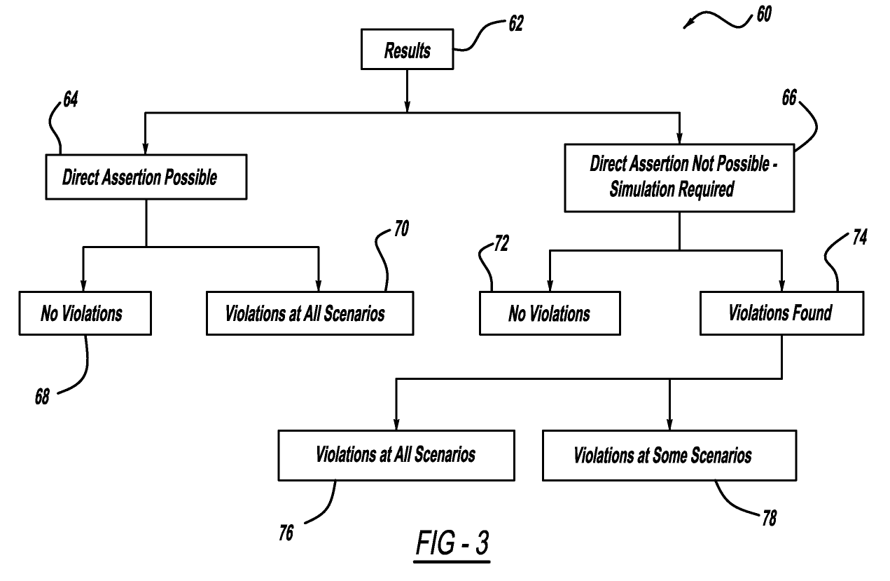

FIG. 3 is a flow chart diagram 60 showing a classification of possible result categories from the results summary 14 that can be presented by the display 22. Certain results can be displayed in certain ways that allow the operator 24 to best understand the results. The results are provided at box 62 and analyzed to determine whether a direct assertion between the PLC logic and the specifications is possible at box 64, where the results can be shown by an assertion tree, or are analyzed to determine whether a direct assertion is not possible between the PLC logic and the specifications, where simulation is required at box 66, where the results can be shown by a reduced ladder logic. If direct assertion is possible at the box 64, then two situations are possible, namely, no violations at box 68 and violations at all scenarios at box 70. If direct assertion is not possible at the box 66 and simulation is required, then two situations are possible, namely, no violations found at box 72 and violations found at box 74. If violations are found at box 74, then violations can be found at all scenarios at box 76 or at some scenarios at box 78.

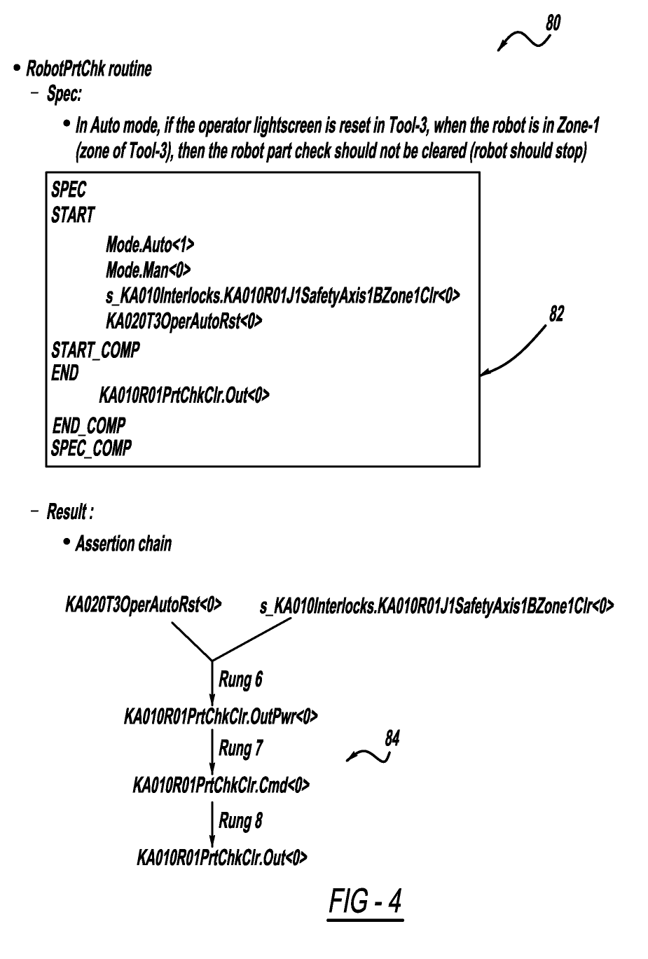

FIG. 4 is an illustration of an example illustrating a direct assertion with no violations found at the box 68 for a robot part check routine. In this example, the operation is in an auto mode where the operators light screen is reset for Tool-3 when a robot is in Zone 1, where the robot part check should not be cleared and the robot should stop. A part specification box 82 shows the specification codes. The specification is written in a crisp format, and the crisp specifications are written into the specification tool. The results show no violation using a direct assertion tree 84. Inputs, KA020T3O per Auto Rst with value 0 and KA010 Interlocks.KA010R01J1 Safety Axis 1 BZone1Clr with value 0, to the assertion tree 84 provide a zero output of end variable (KA010R01PrtChkClr.Out) at rung 8, which meets the specification requirements, indicating no violations at any scenarios.

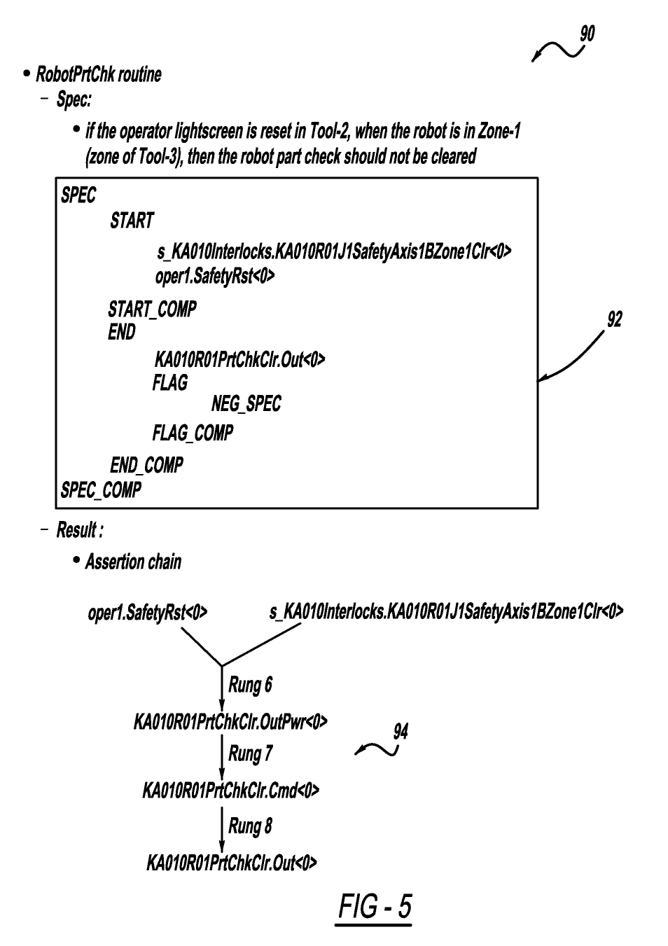

FIG. 5 is an illustration of an example illustrating a direct assertion with violations at all scenarios at the box 70 for a robot part check routine. The operator light screen is reset for Tool-2 when the robot is in Zone-1, where the robot part check should not be cleared. The robot specifications are provided in box 92 and a resulting assertion tree 94 is provided. In this example, rung 8 of the assertion tree 94 should result in an output of 1 for the robot part check (variable KA010R01PrtChkClr.Out) for no violations, which did not occur indicating errors.

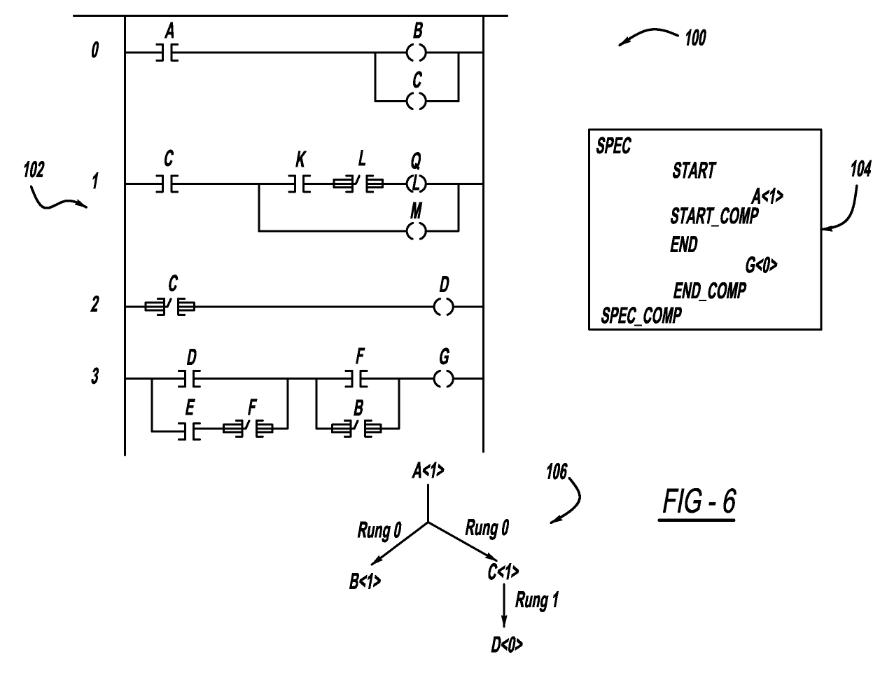

FIG. 6 is an illustration 100 showing a ladder structure 102 representing the PLC logic input to the verifier tool 12 including lines of code 0, 1, 2, 3 and specifications 104 representing the specifications input to the verifier tool 12. If the ladder structure 102 and the specifications 104 are of the type that allow direct assertion, then an assertion tree 106 can show that there are no errors, errors at all scenarios or no direct assertion available regarding given specification. If the assertion tree 106, is not available for given specification, the operator 24 need to conduct simulation for further analysis, then the operator 24 can select one of the three options at the boxes 32, 34 and 38 discussed above, specifically, identify the errors and the problem, identify whether the specification seems to be invalid or incomplete, or refine the results and seek further information to identify the root cause of the errors.

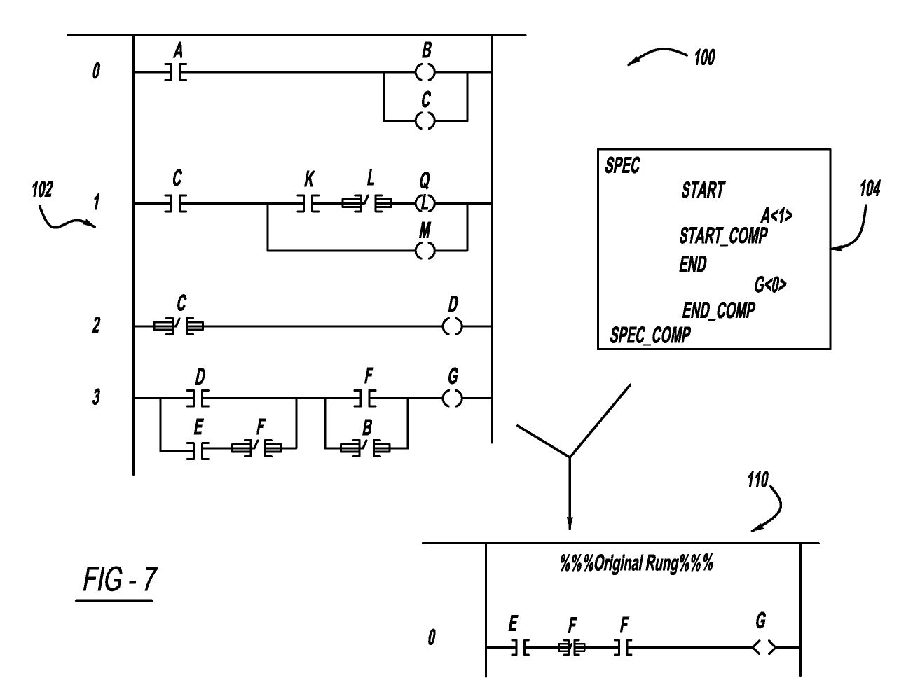

The illustration 100 can be used to illustrate simulations where direct assertions are not possible at the box 66. Thus, if the ladder structure 102 and the specification 104 do not allow for direct assertion, and require a simulation, then the simulation cannot generate the assertion tree 106, but will conduct simulation based on a reduced ladder logic to test all the possible scenarios. This is shown by the illustration 100 in FIG. 7 where the ladder structure 102 and the specification 104 are calculated to generate a reduced ladder logic 110 including a single line of code. The reduced ladder logic 110 can be used for further simulation to show that no violations are found at the box 72, that violations are found at all scenarios at the box 76 and that violations are found at some scenarios at the box 78. If the reduced ladder logic 110 shows that there are errors, then the operator can select one of the three options at the boxes 32, 34 and 38 discussed above, specifically, identify the errors and the problem, identify whether the specification seems to be invalid or incomplete, or refine the results and seek further information to identify the root cause of the errors.

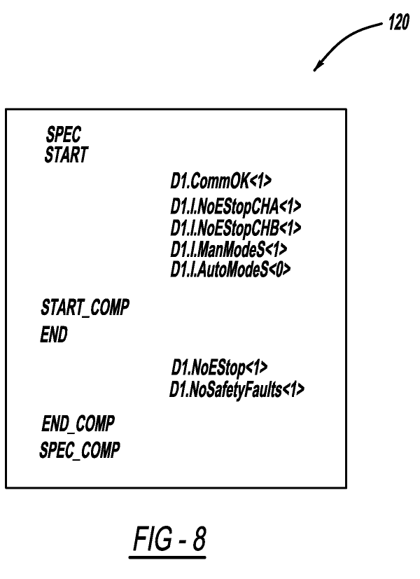

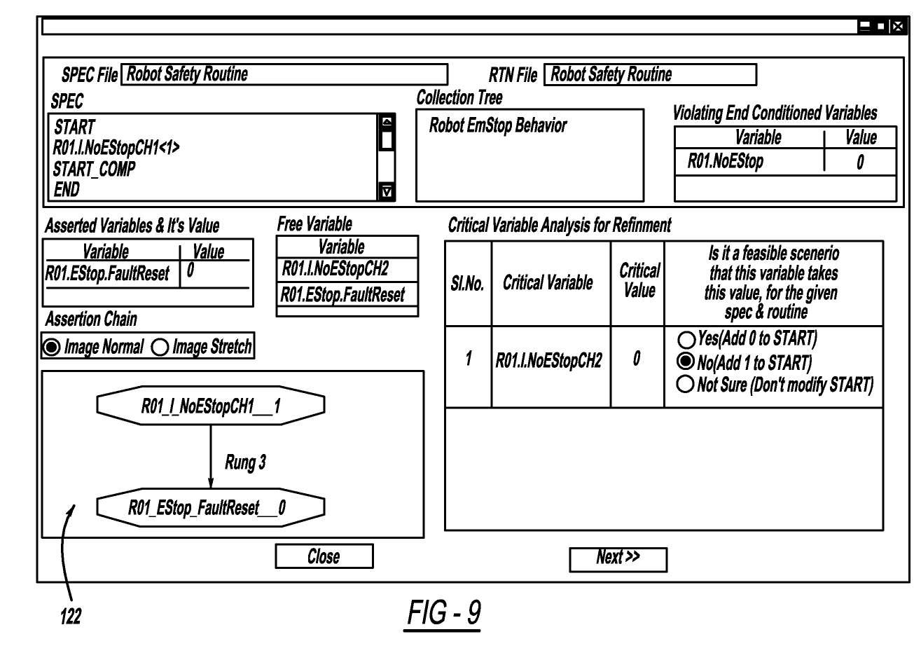

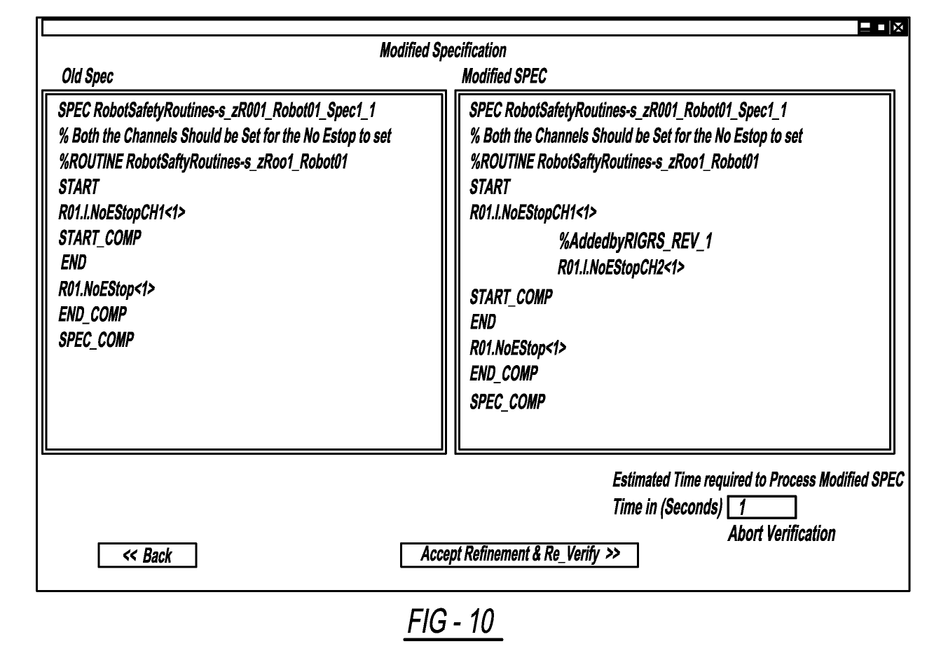

FIGS. 8, 9 and 10 provide an illustration of the simulation for violations at some scenarios at the box 78. FIG. 8 shows specifications 120 of an HMI validation routine when the ESTOP is not activated and the manual mode is selected in the mode selector switch where the system should reflect that it is in its status. The specification 120 requires that the HMI stay at no Estop (D1.NoEStop=1) and no safety fault (D1.NoSafetyfaults=1) state. The formal verification tells the user that there are some violations found through simulation. FIG. 9 shows an assertion tree 122, which only asserts the variable R01.EStop.FaultReset value is 0, but cannot assert any end variable D1.NoEStop or D1.NoSafetyFaults. The simulation runs and determines that R01.NOESTOPCH2 is a variable that relates to the violations where it is proposed that three specification refinements are available to the user. These three options include set R01.NOESTOPCH2 value to 0 as a start condition, set R01.NOESTOPCH2 valued to 1 as a start condition or do nothing. Options 1 and 2 can either result in no violation or a violation at all scenarios through the changes. FIG. 10 shows refined specifications before and after the simulation.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for verifying a manufacturing process, said method comprising:
providing a verifier tool that represents the manufacturing process by mathematical models and algorithms;
inputting programmable logic controller (PLC) logic code and specifications to the verifier tool;
providing a results summary of the simulated manufacturing process from the verifier tool;
analyzing the results summary to determine whether violations are found in the simulated manufacturing process;
displaying the results using an assertion tree if a direct assertion is possible between the PLC logic and the specifications; and
displaying the results using a reduced ladder logic if a direct assertion between the PLC logic and the specifications is not possible, where a simulation is required.

2. The method according to claim 1 further comprising viewing the assertion tree or the reduced ladder logic to determine if there are errors in the process, and documenting the errors if they are identifiable.

3. The method according to claim 1 further comprising viewing the reduced ladder logic or the assertion tree, determining that the process includes errors, determining that the specifications seems to be invalid or incomplete, and refining the specifications in the verifier tool.

4. The method according to claim 1 further comprising viewing the assertion tree or the reduced ladder logic, determining that the process seems to have errors, determining whether refinement of the specification is possible, and refining the specifications in the verifier tool.

5. The method according to claim 1 further comprising displaying critical variables and values in response to analyzing the results summary.

6. The method according to claim 1 wherein the results summary is provided as a direct assertion.

7. The method according to claim 6 wherein the results summary can show no violations if direct assertion between the PLC logic and the specifications is possible.

8. The method according to claim 6 wherein the results summary can show violations at all scenarios if direct assertion between the PLC logic and the specifications is possible.

9. The method according to claim 6 wherein the results summary can show no violations if direct assertion between the PLC logic and the specifications is not possible.

10. The method according to claim 6 wherein the results summary can show violations at all scenarios if direct assertion between the PLC logic and the specifications is not possible.

11. The method according to claim 6 wherein the results summary can show violations at some scenarios if direct assertion between the PLC logic and the specifications is not possible.

12. A method for verifying an automated process, said method comprising:
representing the automated process by mathematical models and algorithm;
operating the automated process using the mathematical models and algorithms in combination with programmable logic controller (PLC) logic code and specifications;
providing a results summary of the automated process;
analyzing the results summary to determine whether violations are found in the automated process; and
displaying the results using an assertion tree or reduced ladder logic.

13. The method according to claim 12 further comprising viewing the assertion tree or the reduced ladder logic to determine if there are errors in the process, and documenting the errors if they are identifiable.

14. The method according to claim 12 further comprising viewing the reduced ladder logic or the assertion tree, determining that the process includes errors, determining that the specifications seems to be invalid or incomplete, and refining the specifications in the verifier tool.

15. The method according to claim 12 further comprising viewing the assertion tree or the reduced ladder logic, determining that the process seems to have errors, determining whether refinement of the specification is possible, and refining the specifications in the verifier tool.

16. The method according to claim 12 wherein the results summary can show no violations if direct assertion between the PLC logic and the specifications is possible.

17. The method according to claim 12 wherein the results summary can show violations at all scenarios if direct assertion between the PLC logic and the specifications is possible.

18. The method according to claim 12 wherein the results summary can show no violations if direct assertion between the PLC logic and the specifications is not possible.

19. The method according to claim 12 wherein the results summary can show violations at all scenarios if direct assertion between the PLC logic and the specifications is not possible.

20. The method according to claim 12 wherein the results summary can show violations at some scenarios if direct assertion between the PLC logic and the specifications is not possible.
